(19) United States
(12) Patent Application Publication
(10) Pub. No.: US 2004/0205511 A1
(43) Pub. Date: Oct. 14, 2004

(54) Method and apparatus for extending browser bookmarks

(75) Inventors: Steven Francis Best, Georgetown, TX (US); Michael Richard Cooper, Austin, TX (US); James Lee Gray, Round Rock, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/142,610

(22) Filed: May 9, 2002

(51) Int. Cl. G06F 17/21

(52) U.S. Cl. 715/501.1; 715/500.1

(57) ABSTRACT

A method, apparatus, and computer instructions for bookmarking a resource. In response to a request to bookmark a location in the resource, a universal resource locator and location information are identified by querying a plug-in for location information for the location in the resource. The universal resource locator and location information are stored as a bookmark in which the bookmark is used to return to the location in the resource.

### BACKGROUND OF THE INVENTION

1. Technical Field

The present invention relates generally to an improved data processing system, and in particular, to a method and apparatus for extending browser bookmarks. Still more particularly, the present invention provides a method and apparatus for providing finer granularity in bookmarking resources.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL).

A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Additionally, a user may save bookmarks or favorites to Web pages or other resources. The use of term “bookmark” is used herein to refer to both a bookmark or a favorite or to an data structure in which a URL is stored. A bookmark is an Internet Web site address, which has been saved by a Web browser. For example, Internet Explorer, which is a browser program available from Microsoft Corporation, saves each bookmark as a single URL file in a selected folder. A user may select one of these bookmarks to retrieve a particular Web page. Other resources that may be bookmarked include read-only documents such as a portable document format (PDF) document. PDF is a page description language used in the Acrobat document exchange system. These documents may range from a few pages long to hundreds of pages long.

Currently, a user is able to generate a bookmark to a document, but not to a particular page in the document. If a user is unable to finish reading a document and generates a bookmark for the document, the user may later retrieve the document to finish reading it. However, the current bookmark system retrieves the resource and presents this resource at the beginning. Thus, a user would have to remember what page they left off in a prior session. Therefore, it would be advantageous to have an improved method, apparatus, and computer instructions for extending browser bookmarks.

### SUMMARY OF THE INVENTION

The present invention provides a method, apparatus, and computer instructions for bookmarking a resource. In response to a request to bookmark a location in the resource, a universal resource locator and location information are identified by querying a plug-in for location information for the location in the resource. The universal resource locator and location information are stored as a bookmark in which the bookmark is used to return to the location in the resource.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components used in bookmarking resources in accordance with a preferred embodiment of the present invention;

FIG. 4 is a diagram illustrating a bookmark in accordance with a preferred embodiment of the present invention;

FIG. 5 is a flowchart of a process used for generating a bookmark in accordance with a preferred embodiment of the present invention; and

FIG. 6 is a flowchart of a process used for presenting a resource in response to the selection of a bookmark in accordance with a preferred embodiment of the present invention.

### DETAILED DESCRIPTION OF THE PREFERRED EMBODIMENT

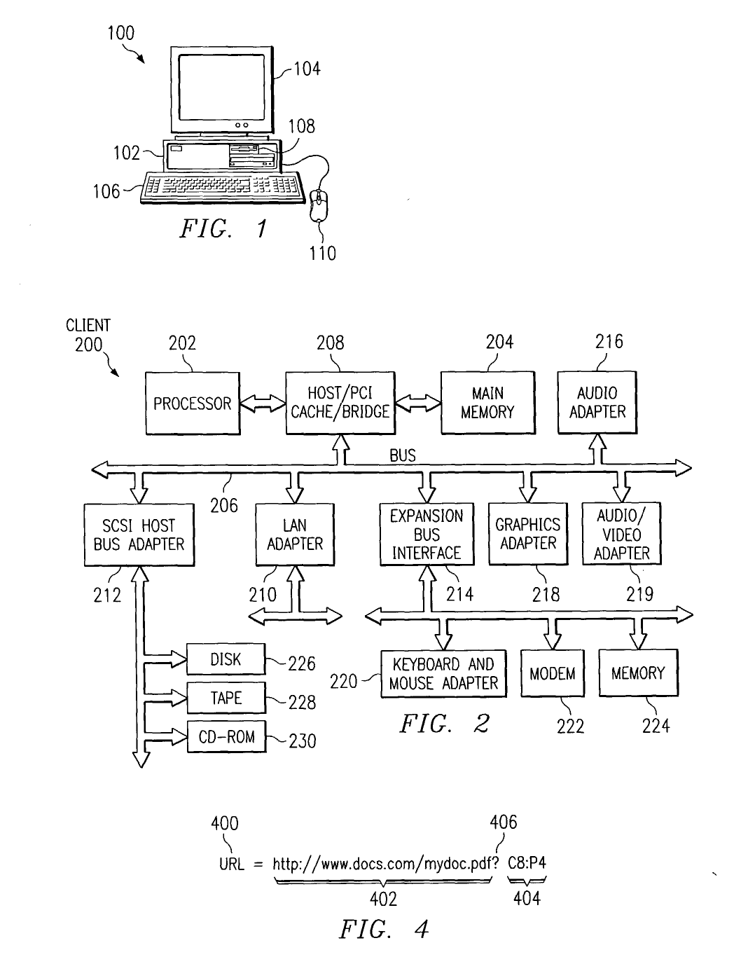

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with read-only memory (ROM) and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices, such as hard disk drive 226, tape drive 228, and CD-ROM 230.

The present invention provides an improved method, apparatus, and computer instructions for extending the current bookmark system found in browsers to allow for the bookmarking of particular portions of a resource. The mechanism of the present invention allows the user to set a bookmark, for example, to a particular page in a PDF document, rather than bookmarking the PDF document itself. The mechanism of the present invention provides a finer granularity in bookmarking resources. The browser bookmark capability or function is modified to support a URL and URL parameters. These parameters are ones that are used to allow bookmarking of a particular portion of a document. For example, these parameters may include, for example, a page number and a line number in the case of a PDF file. Further, a Web page may be bookmarked for a particular location using the parameters. In this instance, the parameters may be a particular word or phrase, which are used by the browser to open the Web page at that point. Other parameters are used depending on the particular resource for which a bookmark is created. In another example, frames or other location information may be used as parameters for streaming audio and/or video resources.

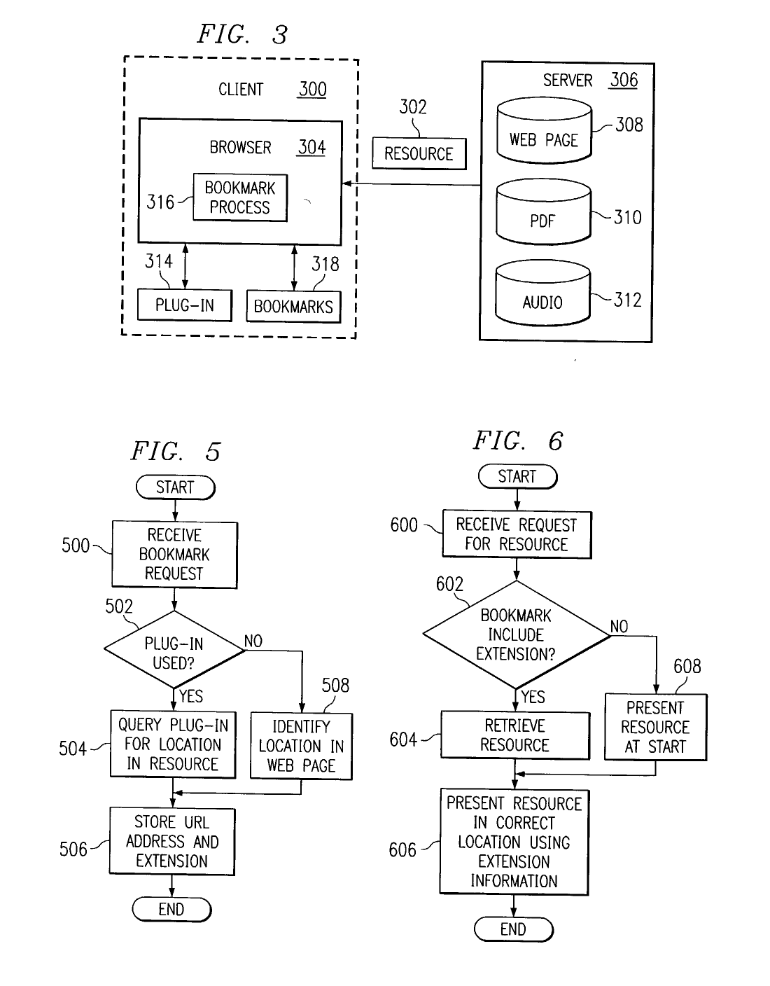

With reference now to FIG. 3, a diagram illustrating components used in bookmarking resources is depicted in accordance with a preferred embodiment of the present invention. In this example, client 300 may be implemented using data processing system 200 in FIG. 2. A user may select resource 302 through browser 304. Resource 302 is received from server 306 and may originate from Web page database 308, PDF file database 310, or audio database 312. Of course, these particular types of resources are provided for purposes of illustration and are not meant to imply any limitations to the types of resources that may be bookmarked using the mechanism of the present invention.

In this example, resource 302 is a PDF document, which is viewed through plug-in 314. A plug-in is an auxiliary program that works with a major software package to enhance its capability. Plug-in 314 works with browser 304 to present resource 302 to the user. Adobe Acrobat Reader is an example of a plug-in used to store and view documents in a PDF format. Adobe Acrobat Reader is a plug-in available from Adobe Systems Incorporated. Macromedia Flash Player is an example of a plug-in used for presenting animations and graphics through browser 304. Macromedia Flash Player is a plug-in available from Macromedia, Inc. Apple QuickTime is another plug-in that allows for the presentation of animation, music, video, and other objects directly in a Web page through browser 304. Apple QuickTime is a plug-in available from Apple Computer, Inc. Plug-ins and similar programs are also referred to as “extensions”.

If the user wishes to be able to retrieve resource 302 again at a later time, the user may initiate a bookmark function through bookmark process 316. Normally, bookmark process 316 saves the URL for the particular resource so that resource may be retrieved at another time. The present invention adds additional features and functionality to bookmark process 316 to save additional information to allow the user to set a bookmark for a particular location within resource 302. This information is also referred to as browser extension bookmark information. With a PDF file, this information includes a URL as well as a page number and a line number. This information is stored in bookmarks 318 for later use.

This additional browser extension bookmark information may be obtained from plug-in 314. For example, with a PDF file, plug-in 314 includes a process to set and clear a bookmark in the document itself. The function or feature employed by plug-in 314 for setting or clearing the bookmark for the document is used to obtain the information stored in bookmarks 318. Bookmark process 316 is designed to include a process for obtaining this information from plug-in 314.

At a later time, if the user selects the bookmark, the URL is used to retrieve resource 302. Further, the browser identifies the additional browser extension bookmark information and uses that information to present resource 302 in the location selected by the user. This additional information may be sent to plug-in 314. For example, the page and line number may be sent to plug-in 314 to have the plug-in present resource 302 at that point. In one implementation, the plug-in may be modified to obtain and send the information needed to create these extended bookmarks and to open resources, such as documents, in the location specified by these extended bookmarks. In another implementation, the plug-in may provide a method or process for use by a user to set a bookmark in the resource. This method would then provide the browser extension bookmark information that is to be stored with the URL for the document.

In another example, bookmarks may be viewed by Adobe Acrobat 5.0, which is available from Adobe Systems Incorporated. Microsoft Word, from Microsoft Corporation, may be used to create a document that has headings, and then the function Acrobat PDFMarker, in Adobe Acrobat 5.0, may be used to create a PDF file from this word document. Part of this process is to convert headings and styles to bookmarks. As a result, the document, called jfs.doc, has the following three headings: (1) Abstract; (2) Body; and (3) Conclusion. Next, a PDF file is created for the jfs.doc with the file being called jfs.pdf. In viewing this file with Adobe Acrobat 5.0, this program will display a table of contents for this document which contain the following bookmarks: Abstract, Body, and Conclusion.

If a user input in the form of a right mouse click is made on the bookmark called “Body”, the program brings up an item that says “Go to Bookmark”, and a user input selecting this item displays the section called “Body” in the document. This example demonstrates the feature of a plug-in, which has bookmarks available to the viewer and the capability to move to the location of the bookmark in the document. In this case, the user only needs to select a bookmark and then this information would be stored as a bookmark containing the URL to the document as well as browser extension bookmark information (BEBI). This storage feature may be performed by adding another item and creating a list of items that may be performed when the bookmark presented by the plug-in is selected. For example, a selection of the bookmark “Body”, causes the following steps to be performed: (1) go to bookmarked location in document; (2) set a new bookmark using URL+BEBI; and (3) remove bookmark containing only the URL from browser bookmark list (URL).

Alternatively, plug-in 314 may provide a bookmark button, which when selected, creates the bookmark in the browser. Selection of this bookmark initiates execution of plug-in 314, which causes browser 304 to retrieve resource 302. Plug-in 314 then presents resource 302 at the appropriate location based on the browser extension bookmark information. In this instance, plug-in 314 includes a process to generate the extended bookmark in bookmarks 318 in conjunction with bookmark process 316.

Turning next to FIG. 4, a diagram illustrating a bookmark is depicted in accordance with a preferred embodiment of the present invention. In this example, bookmark 400 includes a URL in section 402 and browser extension bookmark information in section 404. Character 406 is used to indicate that browser extension bookmark information is present. In this example, bookmark 400 includes chapter 8 and paragraph 4 as the browser extension bookmark information. This information is sent to the plug-in to present the file doc.pdf as identified in section 402 on chapter 8, paragraph 4.

With reference now to FIG. 5, a flowchart of a process used for generating a bookmark is depicted in accordance with a preferred embodiment of the present invention. The process illustrated in FIG. 5 may be implemented in a bookmark process, such as bookmark process 316 in FIG. 3.

The process begins by receiving a bookmark request (step 500). Next, a determination is made as to whether a plug-in is used in presenting the resource being bookmarked (step 502). If a plug-in is used, the plug-in is queried for the location in the resource (step 504). This location may be, for example, a chapter and paragraph, a page and line number, an object reference, or a streaming video/audio location. This information forms the extension to the bookmark, such as illustrated above in FIG. 4. The URL address and extension are stored (step 506) with the process terminating thereafter.

Referring again to step 502, if a plug-in is not used, the location in the Web page is identified (step 508) and the process terminates thereafter.

Turning now to FIG. 6, a flowchart of a process used for presenting a resource in response to the selection of a bookmark is depicted in accordance with a preferred embodiment of the present invention. The process illustrated in FIG. 6 may be implemented in a bookmark process, such as bookmark process 316 in FIG. 3.

The process begins by receiving a request for a resource (step 600). Next, a determination is made as to whether the bookmark includes an extension (step 602). The extension is browser extension bookmark information, such as that found in section 404 of bookmark 400 in FIG. 4. If the bookmark does include an extension, the resource is retrieved (step 604). The resource is presented in the correct location using the extension information (step 606) and the process terminates thereafter.

Referring again to step 602, if the bookmark does not include an extension, the resource is presented at the start (step 608) and the process terminates.

Thus, the present invention provides an improved method, apparatus, and computer implemented instructions for bookmarking specific locations and resources, such as a PDF document or an audio/video file. Additional information as to the specific location selected by the user is stored along with the URL to generate the bookmark of the present invention. In this manner, a user may have a place marked of where the user left off reading a large document or electronic book. Further, bookmarking a portion of a Web page may eliminate presentation of a banner ad located at the top of the Web page. If a user is watching a video and needs to stop and restart the video at a later time, the bookmark function of the present invention may be used to retrieve the video and restart the video from the point selected by the user.

Further, this bookmarking feature may be initiated by user input actively requesting a bookmark to be created. Alternatively, the bookmark feature may be initiated each time the user starts or stops presentation of a resource, such as a video. This feature also may be initiated through user input setting a bookmark in the document itself.

With respect to setting a bookmark in a document, currently this bookmark does not allow retrieval of the document and its presentation at the specified location in response to the selection of the bookmark through a browser in which a plug-in is used in conjunction with presenting the resource. For example, if the user bookmarks a PDF file, the following URL is stored: www.story.com/book/ifs.pdf. If the user sets a bookmark through the plug-in in this PDF file to be chapter 8 paragraph 2, the bookmark stored by the browser is altered to include browser extension bookmark information. The bookmark now has the following information contained within it: www.story.com/book/ifs.pdf?C8:P2. If the user then reads more of this PDF file, clears the chapter 8 paragraph 2 bookmark, and then sets a new bookmark in the PDF file as chapter 9 paragraph 4, the mechanism of the present invention alters the bookmark as follows: www.story.com/book/jfs.pdf?C9:P4. With this example, each time the user initiates a bookmark function within the plug-in, this user input is detected as a bookmark request by the bookmark process within the browser to generate a bookmark for later use in retrieving the resource and presenting the resource at the location selected by the user. This example involves the use of both a bookmark features within the plug-in as well as the bookmark process provided through the browser.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for bookmarking a resource, the method comprising:
responsive to a request to bookmark a location in the resource, querying a plug-in for location information for the location in the resource; and
storing the universal resource locator and location information as a bookmark, wherein the bookmark is used to return to the location in the resource.

2. The method of claim 1 further comprising:
responsive to a selection of the bookmark, retrieving the resource; and
presenting the resource at the location using the location information.

3. The method of claim 1, wherein the resource is one of a Web page, a video file, and an audio file.

4. The method of claim 1, wherein the identifying step and the storing step are performed in a browser in the data processing system.

5. The method of claim 1 further comprising:
responsive to a selection of the bookmark, initiating execution of the plug-in; and
sending the location information to the plug-in to present the resource at the location using the location information.

6. A method in a data processing system for processing information for display, the method comprising:
creating an interface between a browser and a plug-in; and
using a browser bookmark feature of the browser to access a specified portion of an object under a control of a plug-in.

7. The method of claim 6 further comprising:
identifying the specific portion and the object in an extended universal resource locator.

8. The method of claim 6, wherein the object is one of a portable document format file, audio file, or a video file.

9. The method of claim 1, further comprising:
presenting a graphical object, wherein the graphical object generates the request.

10. The method of claim 9, wherein the graphical object is a button displayed in a browser window.

11. A method in a data processing system for processing information for presentation, the method comprising:
receiving a selection of a bookmark feature of a browser to bookmark a specified location of an object being presented under a control of a plug-in;
querying the plug-in for additional bookmark identification information to identify the specified location;
storing the additional bookmark information as part of a universal resource locator address;
receiving a selection of the universal resource locator address in the bookmark feature;
executing the plug-in in response to the selection; and
sending the additional bookmark identification information to the plug-in for use in presenting the object at the specified location.

12. The method of claim 11, wherein the additional information includes at least including one of a page number, a line number, an object reference, a streaming video location, and a streaming audio location.

13. The method of claim 11, wherein the selection of the bookmark reference is enabled though a graphical user interface to the plug-in.

14. A method in a data processing system for processing information for display, the method comprising:
displaying, by an extension, a portion of a resource at a location within the resource and a selectable bookmark function;
causing a bookmark to be created in a browser using a universal resource locator and additional information, generated by the extension, specifying the location;
closing the resource by the extension; and
redisplaying, by the extension, the resource at the location within the resource in response to receiving the additional information from the browser when the universal resource locator is selected in the browser.

15. The method of claim 14, wherein the extension is a plug-in used to present documents.

16. A data processing system bookmarking a resource, the data processing system comprising:
a bus system;
a communications unit connected to the bus system;
a memory connected to the bus system, wherein the memory includes a set of instructions; and
a processing unit connected to the bus system, wherein the processing unit executes the set of instructions to query a plug-in for location information for the location in the resource in response to a request to bookmark a location in the resource; and
store the universal resource locator and location information as a bookmark, wherein the bookmark is used to return to the location in the resource.

17. A data processing system for processing information for display, the data processing system comprising:
a bus system;
a communications unit connected to the bus system;
a memory connected to the bus system, wherein the memory includes a set of instructions; and
a processing unit connected to the bus system, wherein the processing unit executes the set of instructions to create an interface between a browser and a plug-in; and use a browser bookmark feature of the browser to access a specified portion of an object under a control of a plug-in.

18. A data processing system for processing information for presentation, the data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a selection of a bookmark feature of a browser to bookmark a specified location of an object being presented under a control of a plug-in; query the plug-in for additional bookmark identification information to identify the specified location; store the additional bookmark information as part of a universal resource locator address; receive a selection of the universal resource locator address in the bookmark feature; execute the plug-in in response to the selection; and send the additional bookmark identification information to the plug-in for use in presenting the object at the specified location.

19. A data processing system processing information for display, the data processing system comprising:
a bus system;
a communications unit connected to the bus system;
a memory connected to the bus system, wherein the memory includes a set of instructions; and
a processing unit connected to the bus system, wherein the processing unit executes the set of instructions to display, by an extension, a portion of a resource at a location within the resource and a selectable bookmark function; cause a bookmark to be created in a browser using a universal resource locator and additional information, generated by the extension, specifying the location; close the resource by the extension; and redisplay, by the extension, the resource at the location within the resource in response to receiving the additional information from the browser when the universal resource locator is selected in the browser.

20. A data processing system for bookmarking a resource, the data processing system comprising:
querying means, responsive to a request to bookmark a location in the resource, for querying a plug-in for location information for the location in the resource; and
storing means for storing the universal resource locator and location information as a bookmark, wherein the bookmark is used to return to the location in the resource.

21. The data processing system of claim 20 further comprising:
retrieving means, responsive to a selection of the bookmark, for retrieving the resource; and
presenting means for presenting the resource at the location using the location information.

22. The data processing system of claim 20 wherein the resource is one of a Web page, a video file, and an audio file.

23. The data processing system of claim 20, wherein the identifying means and the storing means are performed in a browser in the data processing system.

24. The data processing system of claim 20 further comprising:
initiating means, responsive to a selection of the bookmark, for initiating execution of the plug-in; and
sending means for sending the location information to the plug-in to present the resource at the location using the location information

25. A data processing system for processing information for display, the data processing system comprising:
creating means for creating an interface between a browser and a plug-in; and
using means for using a browser bookmark feature of the browser to access a specified portion of an object under a control of a plug-in.

26. The data processing system of claim 25 further comprising:
identifying means for identifying the specific portion and the object in an extended universal resource locator.

27. The data processing system of claim 25, wherein the object is one of a portable document format file, audio file, or a video file.

28. The data processing sytem of claim 25, further comprising:
presenting means for presenting a graphical object, wherein the graphical object generates the request.

29. The data processing system of claim 25, wherein the graphical object is a button displayed in a browser window.

30. A data processing system for processing information for presentation, the data processing system comprising:
first receiving means for receiving a selection of a bookmark feature of a browser to bookmark a specified location of an object being presented under a control of a plug-in;
querying means for querying the plug-in for additional bookmark identification information to identify the specified location;
storing means for storing the additional bookmark information as part of a universal resource locator address;
second receiving means for receiving a selection of the universal resource locator address in the bookmark feature;
executing means for executing the plug-in in response to the selection; and
sending means for sending the additional bookmark identification information to the plug-in for use in presenting the object at the specified location.

31. The data processing sytem of claim 30, wherein the additional information includes at least including one of a page number, a line number, an object reference, a streaming video location, and a streaming audio location.

32. The data processing system of claim 30, wherein the selection of the bookmark reference is enabled though a graphical user interface to the plug-in.

33. A data processing system for processing information for display, the data processing system comprising:
displaying means for displaying, by an extension, a portion of a resource at a location within the resource and a selectable bookmark function;
causing means for causing a bookmark to be created in a browser using a universal resource locator and additional information, generated by the extension, specifying the location;
closing means for closing the resource by the extension; and
redisplaying means for redisplaying, by the extension, the resource at the location within the resource in response to receiving the additional information from the browser when the universal resource locator is selected in the browser.

34. The data processing system of claim 33, wherein the extension is a plug-in used to present documents.

35. A computer program product in a computer readable medium for bookmarking a resource, the computer program product comprising:
first instructions, responsive to a request to bookmark a location in the resource, for querying a plug-in for location information for the location in the resource; and
second instructions for storing the universal resource locator and location information as a bookmark, wherein the bookmark is used to return to the location in the resource.

36. A computer program product in a computer readable medium for processing information for display, the computer program product comprising:
first instructions for creating an interface between a browser and a plug-in; and
second instructions for using a browser bookmark feature of the browser to access a specified portion of an object under a control of a plug-in.

37. A computer program product in a computer readable medium for processing information for presentation, the computer program product comprising:
first instructions for receiving a selection of a bookmark feature of a browser to bookmark a specified location of an object being presented under a control of a plug-in;
second instructions for querying the plug-in for additional bookmark identification information to identify the specified location;
third instructions for storing the additional bookmark information as part of a universal resource locator address;
fourth instructions for receiving a selection of the universal resource locator address in the bookmark feature;
fifth instructions for executing the plug-in in response to the selection; and
sixth instructions for sending the additional bookmark identification information to the plug-in for use in presenting the object at the specified location.

38. A computer program product in a computer readable medium for processing information for display, the computer program product comprising:
first instructions for displaying, by an extension, a portion of a resource at a location within the resource and a selectable bookmark function;
second instructions for causing a bookmark to be created in a browser using a universal resource locator and additional information, generated by the extension, specifying the location;
third instructions for closing the resource by the extension; and
fourth instructions for redisplaying, by the extension, the resource at the location within the resource in response to receiving the additional information from the browser when the universal resource locator is selected in the browser.
